(19) United States
(12) Patent Application Publication
(10) Pub. No.: US 2019/0110040 A1
(43) Pub. Date: Apr. 11, 2019

(54) METHOD FOR ENHANCING VIEWING COMFORT OF A MULTI-VIEW CONTENT, CORRESPONDING COMPUTER PROGRAM PRODUCT, COMPUTER READABLE CARRIER MEDIUM AND DEVICE

(71) Applicant: InterDigital CE Patent Holdings, Paris (FR)

(72) Inventors: Didier DOYEN, La Bouexiere (FR); Franck GALPIN, Thorigné Fouillard (FR); Sylvain THIEBAUD, Noyal sur Vilaine (FR)

(21) Appl. No.: 16/086,591

(22) PCT Filed: Mar. 20, 2017
(86) PCT No.: PCT/EP2017/056570

§ 371 Date: Sep. 19, 2018

(30) Foreign Application Priority Data
Mar. 21, 2016 (EP) 16305309.3

(51) Int. Cl. H04N 13/128; H04N 13/122; G06T 5/00; H04N 13/268

(52) U.S. Cl. CPC H04N 13/128; H04N 13/268; G06T 5/002; H04N 13/122

(57) ABSTRACT

The disclosure relates to a method for obtaining a modified multi-view content from an original multi-view content, said method being characterized in that it comprises: determining (20), from a disparity-related map, a separation line separating adjacent first and second image regions, comprising at least one line portion each separating adjacent first and second image portions belonging respectively to the first image region and the second image region and such that a disparity-related value difference between the first and the second image portion is higher than a disparity-related value difference between the first and the second portion is higher than a disparity-related value difference threshold; obtaining (40) a modified multi-view content by blurring a visual discomfort area that is an area of the second image region, which extends from the separation line over a given distance.

### 1. TECHNICAL FIELD

The present disclosure relates to multi-view imaging. More particularly, the disclosure pertains to a technique for enhancing viewing comfort of a multi-view content (i.e. a content comprising at least two views) perceived by a viewer.

Such a multi-view content can be obtained for example from a light-field content, a stereoscopic content (comprising two views), or from a synthesized content.

The present disclosure can be applied notably, but not exclusively, to content for 3D stereoscopic display or multi-view autostereoscopic display.

### 2. BACKGROUND

This section is intended to introduce the reader to various aspects of art, which may be related to various aspects of the present disclosure that are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

In spite of improvements made recently in this technological field, stereoscopic vision is one of the most investigated topics since the beginning in computer vision, with many issues still unsolved. Stereoscopic images are able to provide viewers with realistic and immersive viewing experience. However, viewers often experience visual discomfort during the viewing process.

One of the main reasons that cause visual discomfort during viewing stereoscopic content is the presence of visual conflicts such as occlusions. An occlusion occurs when a part of the content is only appearing in one of two stereoscopic images (a “right” image intended to the right eye and a “left” image intended to the left eye). For instance, in a scene containing a foreground object in background environment, the background is partially occluded behind the foreground object. It can appear on one image (i.e. on one eye) but not the other image of the stereoscopic pair (i.e. on the other eye). This conflict creates visual discomfort during the rendering of stereoscopic content.

Indeed, one of the main differences for an observer between viewing a stereoscopic content on a display and looking at a real scene is the focus/accommodation principle of the eye/brain. When the viewer focuses on a foreground object of the scene, this latter is in focus and the remaining elements of the scene (which are outside a certain distance around the focus distance) are out of focus. This is not true with a stereoscopic content in which every elements—both foreground and background elements—can be in focus at the same time (since there is no way for the content creator to know where the viewer will look at). The stereoscopic content can then have one or several foreground objects masking a part or parts of the background on one eye and not on the other one.

The occlusion problem in stereoscopic content also appears in the context of content insertion into stereoscopic content, such as subtitle insertion or graphic insertion (e.g. OSD interface) for example. To be correctly viewed in stereo the graphic should be placed in front of the content on top of any object of the scene. But doing so means that there could be a huge difference in depth between this graphic and the background of the scene. The occlusion can then be very noticeable and annoying.

There is a need for providing a technique for reducing viewing discomfort of a stereoscopic content due to the presence of occlusions.

### 3. SUMMARY OF THE DISCLOSURE

References in the specification to “one embodiment”, “an embodiment”, “an example embodiment”, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

A particular embodiment of the disclosure proposes a method for obtaining a modified multi-view content from an original multi-view content, said method being comprising:
determining, from a disparity-related map, at least one separation line separating adjacent first and second image regions, said at least one separation line comprising at least one line portion each separating adjacent first and second image portions belonging respectively to the first image region and the second image region and such that a disparity-related value difference between the first and the second image portion is higher than a disparity-related value difference threshold;
   and for a given separation line of said at least one separation line:
defining (30) an area of the second image region, called visual discomfort area, which extends from said given separation line over a given distance;
obtaining (40) a modified multi-view content by blurring said visual discomfort area.

The general principle of the disclosure is that of blurring the parts of image of a multi-view content that could create a visual discomfort due to the presence of occlusions in this multi-view content (i.e. image zones appearing in only one of a pair of stereoscopic images).

To that end, the disclosure relies on the determination of a visual discomfort area in the multi-view content by analysis of local disparity or depth variations in the disparity-related map. The visual discomfort area is a zone of probable presence of an occlusion defined in the second image region and which extends from the separation line separating the first and second image regions over a distance which depends on the local disparity variations.

Blurring the visual discomfort areas in the multi-view content enhances viewing comfort of the multi-view content perceived by a user. Indeed, a zone of image in the original multi-view content where an occlusion happens, but where an image blurring is applied, is better accepted when viewing the multi-view content. By ‘blurring’ it means an image processing consisting in voluntary reducing the level of sharpness of the concerned image zone (i.e. the visual discomfort area) so as to reduce the level of detail of this area. This means defocusing the visual discomfort area to provide a modified multi-view content in which the effect of occlusions is reduced by the blurring effect.

Note that the method can be particularly carried out such that said step of defining a visual discomfort area is carried out for each separation line determined from the disparity-related map.

According to a particular feature, the disparity-related map is a disparity map, the disparity-related value difference is a difference of disparity, a first image portion of the first image region is defined as having a disparity lower than that of the corresponding adjacent second image portion of the second image region.

Assuming for example that the first image region corresponds to foreground and the second image region corresponding to background, the visual discomfort area is therefore defined within the background from the separation line.

According to an alternative embodiment, the disparity-related map is a depth map, the disparity-related value difference is a difference of depth, a first image portion of the first image region is defined as having a depth lower than that of the corresponding adjacent second image portion of the second image region.

In that case, the reference point for depth values contained in the depth map is the capture system.

Assuming for example that the first image region corresponds to foreground and the second image region corresponding to background, the visual discomfort area is therefore defined within the background from the separation line.

According to a particular feature, the given distance over which said visual discomfort area extends from said separation line is a predefined distance.

According to an alternative embodiment, the given distance over which said visual discomfort area extends from said separation line depends on the disparity-related value difference between the first and second image portion separated each line portion of said given separation line.

Thus higher the disparity-related value difference is, higher the given distance of the visual discomfort area will be.

According to a particular feature, the disparity-related value difference threshold is defined as a function of a binocular angular disparity criterion.

The binocular angular disparity criterion is for instance an angular deviation between a first binocular visual angle defined from a foreground plane and a second binocular visual angle defined from a background plane.

According to a first particular embodiment, blurring said visual discomfort area consists in applying an image blurring function, belonging to the group comprising:
a linear decreasing blurring function starting from said separation line;
a non-linear decreasing blurring function starting from said separation line;
a Gaussian blurring function;
a constant blurring function.

The image blurring function is applied on all the distance of the visual discomfort area. It can depend on the distance between the separation line and the point of the area where the blur is actually applied, allowing a progressive reduction of image details of the visual discomfort area, and so a better acceptation of occlusions in the multi-view content perceived by the viewer. In other words, the closer one is the separation line, the more pronounced the blurring effect is.

According to a second particular embodiment, the original multi-view content is obtained from a light-field content comprising a focal stack to which is associated the disparity-related map, said focal stack comprising a set of images of a same scene focused at different focalization distances, and blurring said visual discomfort area consists in:
selecting an image area, called out-of-focus area, in at least one image of the focal stack, corresponding to the visual discomfort area which is out-of-focus;
generating the modified multi-view content as function of the out-of-focus area selected.

This second particular embodiment is interesting in that it takes advantage of information contained in the focal stack of the light-filed content to make the visual discomfort area blurred. This ensures to have a blurring effect of better quality than that obtained by image processing using an image blurring function.

According to a particular feature, the out-of-focus area comprises at least two out-of-focus area portions which are selected in at least two distinct images of the focal stack, the out-of-focus area portion of first level which extends from said separation line being selected in an image of first out-of-focus level of the focal stack and each out-of-focus area portion of inferior level being selected in an image of inferior out-of-focus level of the focal stack.

It is therefore possible to choose several images of the focal stack for which the out-of-focus area has different out-of-focus levels so as to obtain a decreasing blurring effect starting from the separation line. We may further envisage defining an out-of-focus threshold on the basis of which the out-of-focus area portion of first level is selected and a focused image selection criterion.

According to a particular feature, the original multi-view content comprises two of stereoscopic views derived from the light-field content, each associated with a disparity-related map, said steps of defining and blurring being carried out for each stereoscopic view.

According to a particular feature, the original multi-view content is a stereoscopic content comprising two stereoscopic views, each associated with a disparity-related map, said step of defining a visual discomfort area and said step of blurring being carried out for each stereoscopic view.

According to a particular feature, the original multi-view content is a synthesized content comprising two synthesized stereoscopic views, each associated with a disparity-related map, said step of defining a visual discomfort area and said step of blurring being carried out for each stereoscopic view.

According to a particular feature, the method comprises a step of inserting, into a foreground plan of the original multi-view content, at least one foreground object, the disparity-related map taking into account said at least one foreground object.

Taking into account foreground objects inserted into a multi-view content (such as subtitle insertions or graphic insertions for example), the visual discomfort perceived by the viewer due to occlusions involved by those foreground objects can therefore be reduced.

In another embodiment, the disclosure pertains to a computer program product comprising program code instructions for implementing the above-mentioned method (in any of its different embodiments) when said program is executed on a computer or a processor.

In another embodiment, the disclosure pertains to a non-transitory computer-readable carrier medium, storing a program which, when executed by a computer or a processor causes the computer or the processor to carry out the above-mentioned method (in any of its different embodiments).

Advantageously, the device comprises means for implementing the steps performed in the method of obtaining as described above, in any of its various embodiments.

In another embodiment, the disclosure pertains to a device for obtaining a modified multi-view content from an original multi-view content, comprising:
determining unit configured to determine, from a disparity-related map, at least one separation line separating adjacent first and second image regions, said at least one separation line comprising at least one line portion each separating adjacent first and second image portions belonging respectively to the first image region and the second image region and such that a disparity-related value difference between the first and the second image portion is higher than a disparity-related value difference threshold;
   and for a given separation line of said at least one separation line:
defining unit configured to define, in the original multi-view content, an area of the second image region, called visual discomfort area, which extends from said separation line over a given distance;
blurring unit configured to blur said visual discomfort area to obtain a modified multi-view content.

### 4. LIST OF FIGURES

Other features and advantages of embodiments of the disclosure shall appear from the following description, given by way of an indicative and non-exhaustive examples and from the appended drawings, of which:

FIG. 1 is a flowchart of a particular embodiment of the method according to the disclosure;

FIG. 2 shows an example of a view of a light-field content from which the method according to the disclosure is implemented;

FIG. 3 shows an example of a depth map obtained from the light-field content;

FIG. 4 shows an example of image illustrating the principle of determining a separation line from the depth map of FIG. 3;

FIG. 5 shows an example of a filtering mask to be applied to the view of FIG. 2;

FIG. 6 shows an example of a filtered view obtained after applying the filtering mask of FIG. 5;

FIGS. 7A-7B are schematic illustrations illustrating the principle of defining a visual discomfort area according to a particular embodiment of the disclosure;

FIG. 8 shows the simplified structure of an image enhancing device according to a particular embodiment of the disclosure;

FIG. 9 is schematic drawing illustrating the principle of selecting an out-of-focus area in a focal stack of a light-field content for enhancing viewing comfort of a multi-view content, according to a particular embodiment of the disclosure.

### 5. DETAILED DESCRIPTION

In all of the figures of the present document, identical elements and steps are designated by the same numerical reference sign.

Here below in this document is described a particular embodiment of the disclosure through an application from a light field content. The disclosure is of course not limited to this particular field of application but is of interest for any technique enhancing viewing comfort of a multi-view content that has to cope with closely related or similar occlusion problem.

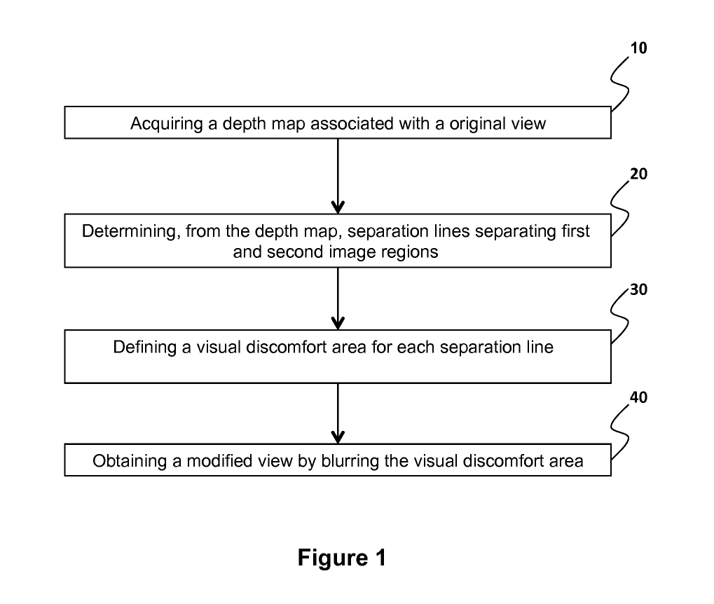

FIG. 1 depicts a method for enhancing viewing comfort of a light-field content according to a particular embodiment of the disclosure. This method is carried out by an image enhancing device 100, the principle of which is described in detail below in relation with FIG. 8. Such a light-field content comprises a plurality of views (i.e. two-dimensional images) of a scene 3D captured from different viewpoints and dedicated to stereoscopic content visualization.

Indeed, a light-field content can be represented by a set of sub-aperture images. A sub-aperture image corresponds to a captured image of a scene from a point of view, the point of view being slightly different between two sub-aperture images. These sub-aperture images give information about the parallax and depth of the imaged scene (see for example the Chapter 3.3 of the Phd dissertation thesis entitled “Digital Light Field Photography” by Ren Ng, published in July 2006).

The plurality of views may be views obtained from focal stacks provided by a light-field capture system, such as a plenoptic system for example, each view being associated with a depth map (also commonly called “z-map”). A focal stack comprises a set of images of the scene focused at different distances and is associated with a given point of view of the captured scene.

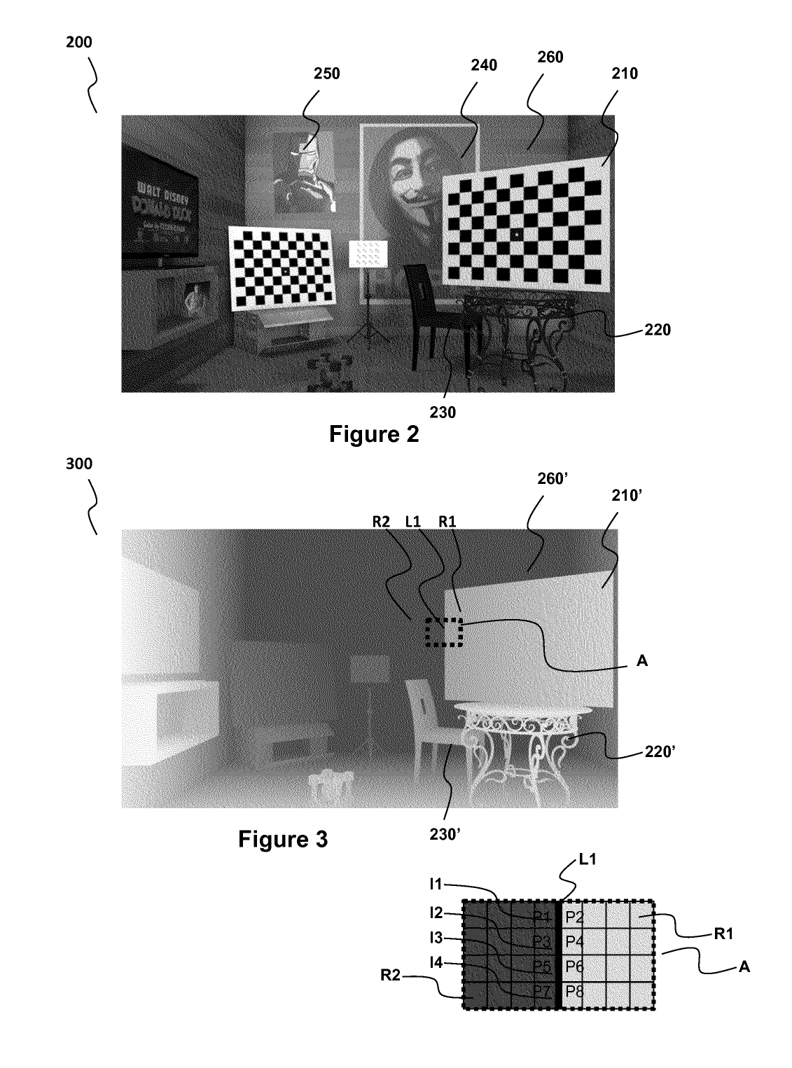

FIG. 2 shows an example of a view 200 belonging to a set of original sixteen views obtained from a light-field content provided by the plenoptic system. This view 200 comprises notably a chessboard 210 placed on the table 220 and a chair 230 which constitute foreground objects, a painting 240 and a poster 250 mounted on a wall 260 which constitute the background. The view 200 is an all-in-focus image (AIF) derived from one of the focal stacks of images of the light-field content.

We hereafter consider that the method is carried out for two stereoscopic views from the set of original views: a first view intended to the viewer's right eye and a second view intended to the viewer's left eye. The view 200 for instance corresponds to a view intended to the right eye.

At step 10, the device 100 first acquires or computes the depth map associated with the first view 200. The depth map 300 showed in FIG. 3 is an example of depth map corresponding to the view 200.

It is pointed out here that the depth map 300 showed in FIG. 3 is a 2D representation (i.e. an image) of the 3D scene captured by the light-field capture system in which each pixel is associated with a depth information displayed in grayscale (the light intensity of each pixel is for instance encoded in grayscale on 16 bits). The depth information is representative of the distance of objects captured in the 3D scene from the capture system. Such a representation gives a better understanding of what is a depth map of a given stereoscopic view. But more generally a depth map comprises depth data relative to the distance between objects in the captured scene and can be stocked as a digital file or table.

Throughout this description, one considers that the notion of depth is defined in relation to the viewer (or the capture system): a foreground object has a depth lower than that of a background object. Of course the skilled person could define the notion of depth not relative to the viewer but relative to the screen or infinity without departing from the scope of the disclosure.

A white pixel on the depth map 300 is associated with a piece of low depth information (this means the corresponding pixel in the original view 200 corresponds to a point in the 3D scene having a low depth relative to the capture system (foreground)). A black pixel on the depth map 300 is associated with a piece of high depth information (this means the corresponding pixel in the original view 200 corresponds to a point in the 3D scene having a high depth relative to the capture system (background)). This choice is arbitrary and the depth map can be established with reverse logic.

The elements 210′, 220′, 230′, 260′ are 2D representation in the depth map 300 of the elements 210, 220, 230, 260 appearing on the view 200 respectively.

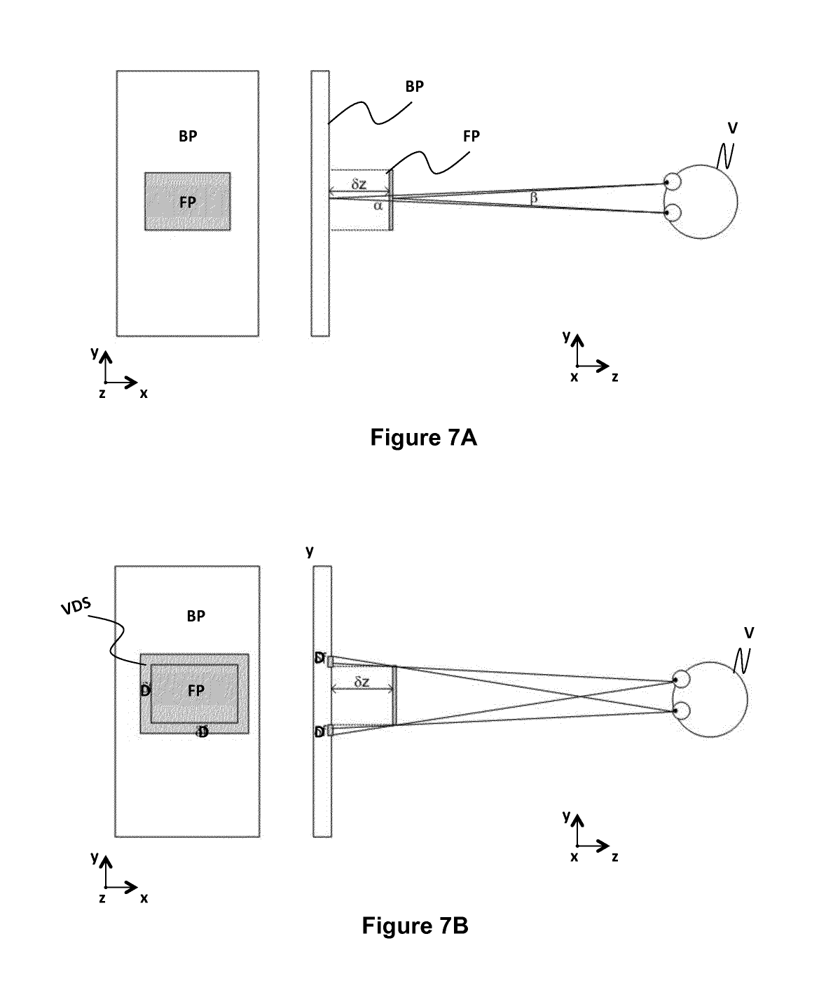

At step 20, the device 100 performs an image analysis, for example pixel-by-pixel, to determine separation lines in the depth map 300 that correspond to a significant change of light intensity (and so a change of depth since a light intensity value is associated with a depth value), i.e. a change of light intensity which is higher than a predefined threshold (the principle of which is described in detail below in relation with FIGS. 7A-7B). The predefined threshold is chosen such that the separation line thus determined corresponds to a transition between two adjacent image regions representative of a foreground region and a background region of the 3D scene.

It should be noted that the light intensity difference to define this separation line between two adjacent image regions is not necessarily constant but it is sufficient that the light intensity difference between two adjacent image portions belonging to two adjacent image region is higher than the predefined light intensity difference threshold.

The image portion is for example a pixel of the depth map 300 as illustrated in the dashed line box A of FIG. 3 (pixel-by-pixel image analysis). Of course we can consider that the image portion is a group of adjacent pixels (2×2 or 4×4 for example), in which case the image processing performed in step 20 would be accelerated.

To simplify understanding of this step, let us take the example of the image part A of FIG. 3 (dash line box). Each pixel of the image part 350 is associated with a value of depth. The device 100 performs a pixel-by-pixel analysis.

The depth value difference between the adjacent pixels P1 and P2 (δz1) being higher than a depth value difference threshold (T) predefined by the device 100, a first line portion 11 separating the adjacent pixels P1 and P2 is then defined. The depth value difference between the adjacent pixels P3 and P4 (δz2), P5 and P6 (δz3), P7 and P8 (δz4) being higher than the predefined depth value difference threshold (T), line portions 12, 13 and 14 respectively separating the adjacent pixels P3 and P4, P5 and P6, P7 and P8 are then defined. The separation line L1 for the part A of the depth map 300 thus determined is composed of the line portions l1, l2, l3 and l4 and delimits the first image region R1 and the second image region R2. Pixels P1, P3, P5, P7 belongs to the first image region R1. Pixels P2, P4, P6, P8 belongs to the second image region R2. The second image region R2 has depth values higher than those of the first image region R1.

The same process is performed to all pixels of the depth map 300.

By way of an example, an edge detection algorithm, such as Sobel filter for example used in image processing or computer vision, can be implemented in step 20 to determine the separation lines according to the disclosure. In particular, Sobel filter is based on a calculation of light intensity gradient of each pixel to create an image with emphasising edges, which emphasising edges constitutes the separation lines according to the disclosure.

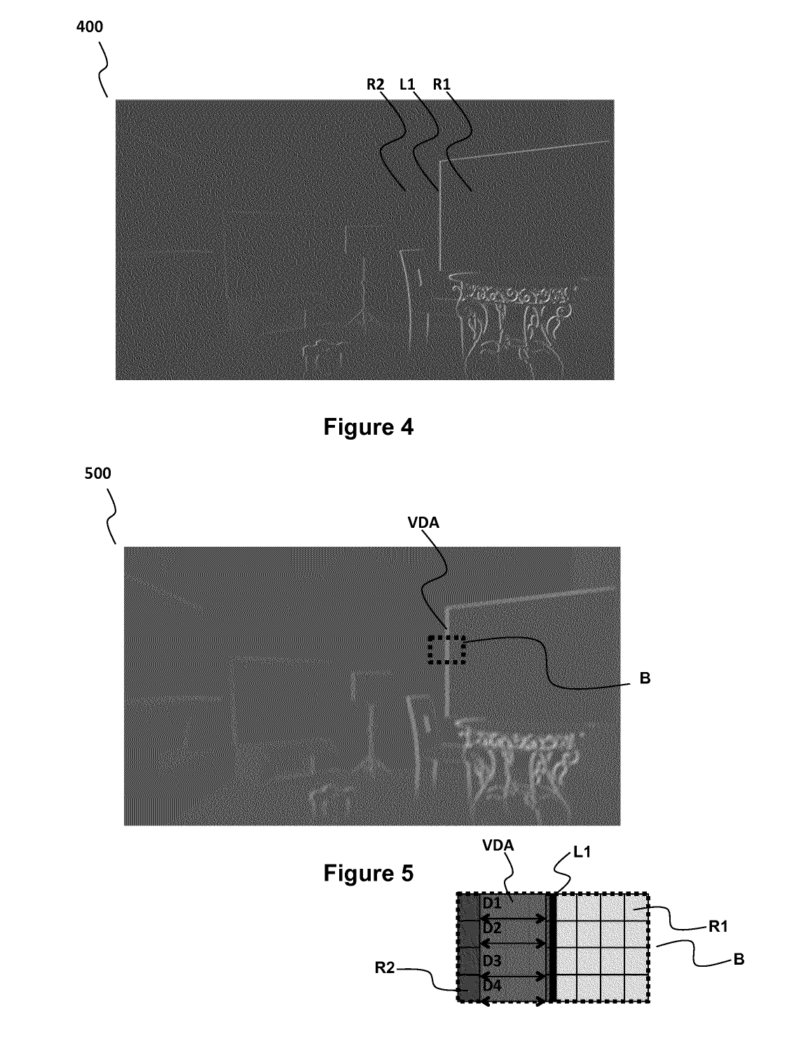

FIG. 4 shows an example of a binary edge image 400 obtained after applying a Sobel filter to the depth map 300. This image 400 illustrates the principle of determining separation lines according to the disclosure. At the end of step 20, several separation lines such as lines L1, L2, L3 are calculated by the device 100.

Sobel filter is a particular example of filter based on a measure of image intensity gradient. Other types of filter based on a measure of image intensity gradient to detect regions of high intensity gap that correspond to edges, can be of course implemented without departing from the scope of the disclosure. For example, edge detection techniques based on Phase stretch transform or Phase congruency-based edge detection can be used.

The edge detection algorithm executed in step 20 must be adapted to the present disclosure, i.e. must be able to determine the separation lines delimiting adjacent first and second image regions in the depth map as a function a desired depth value difference threshold.

Other image processing based on segmentation for example can be also applied to identify from the depth map first and second regions based on a desired depth value difference threshold, needed to continue the method.

At step 30, the device 100 defines, for each of the separation lines determined at previous step 20, a visual discomfort area. A visual discomfort area is an area of the second image region considered as being a potential source of visual discomfort due to the presence of occlusions in the multi-view content. Indeed, the second image region has high depth information relative to the first image region, meaning it corresponds to a background plan that can be partially occulted by a foreground object.

Let us take more particularly the example of the separation line L1 illustrated on FIGS. 3-4 and more in details in dash line box B of FIG. 5. The visual discomfort area VDA is defined as being an area of the second image region R2 which extends from the separation line L1 over a distance Di which depends on, for each line portion (i.e. l1, l2, l3, l4) of the separation line L1, the depth value difference (i.e. δz1, δz2, δz3, δz4 respectively) calculated between the first and second adjacent image portions (i.e. P1-P2, P3-P4, P5-P6, P7-P8 respectively) separated by that line portion. D1, D2, D3, D4 corresponds to the distance over which the visual discomfort area VDA extends respectively from the line portions l1, l2, l3, l4.

To simplify the figure and associated description, we consider here the distance Di over which the visual discomfort area VDA extends from the separation line is constant (3 pixels for example here). But it depends, for a given line portion, on the depth value difference locally calculated between the first and second adjacent image portions corresponding to that given line portion.

In one embodiment of the disclosure, the distance Di can be different for each processed line pixels (i.e. D1 can be different from D2, and so on).

In another embodiment of the disclosure, the distance Di can be equal for several processed line pixels (i.e. D1 to D4 can be equal).

In another embodiment of the disclosure, the distance Di can have a value belonging to a range that starts from the value of one pixel to end up with the value of 32 pixels.

At step 40, the device 100 will apply a processing that makes the visual discomfort area VDA defined in step 30.

Below are described two particular embodiments of step 40 that the device 100 can carried out.

### First Particular Embodiment (Using an Image Filter)

The first embodiment is based on an image processing to apply a blurring function to the visual discomfort area VDA.

To that end, the device 100 creates a filtering mask 500, such as that illustrated in FIG. 5, which integrates an image blurring function only associated with the visual discomfort area VDA previously defined. The filtering mask 500 is intended to be applied to the original view 200.

In an exemplary example, the filtering mask 500 according to the disclosure is based on a decreasing linear blurring function configured to blur the visual discomfort area over all the distance over which the visual discomfort area VDA extends, starting from the separation line L1. Such a blurring function aims at progressively reducing image details in the second region R2 where the visual discomfort area is defined from the separation line L1, for a better acceptation of occlusions in the multi-view content perceived by the viewer. In other words, the blurring function of filtering mask 500 is such that the closer one is the separation line between the regions R1 and R2, the more pronounced the blurring effect is. The mask effect is therefore at its maximum at the limit corresponding to the separation line L1.

But that is just one example and one may also envisage applying an image blurring to the original view 200 with a non-linear decreasing function or a Gaussian function or a constant function, starting from the separation line L1. One may also envisage applying an image blurring to the view 200 with a mask that performed a function depending on the depth value difference calculated for each line portion of the separation line L1.

Then the device 100 applies the filtering mask 500 thus created to the first original view 200 to obtain a first filtered view 600. Thus the image parts of the view 200 corresponding to the visual discomfort areas are made blurred to have a better acceptation of occlusions in the multi-view content perceived by the viewer.

The same steps 10 to 40 are also performed, sequentially or simultaneously, on a second original view (not shown on figures) of the light-field content, in order to provide a second filtered view as explained above. Based on the first and second filtered views, the device 100 generates a stereoscopic content for which viewing comfort has been enhanced.

### Second Particular Embodiment (Using a Focal Stack)

In this the second embodiment the devices 100 takes advantage of information contained in the focal stack of the light-filed content to make the image blurring. This ensures to have a blurring effect of better quality than the one obtained by the image processing described above in relation with the first embodiment.

We should remember that the view 200 is an all-in-focus image derived from the focal stack of images of a light-field content. The focal stack comprises a set of images of a same scene focused at different distances and is associated to the depth image 300. The focal stack is associated with given point of view. The device 100 receives as an input the focal stack (FS), the depth map (300) and the AIF view (200) (which corresponds to the first step 10 of the algorithm).

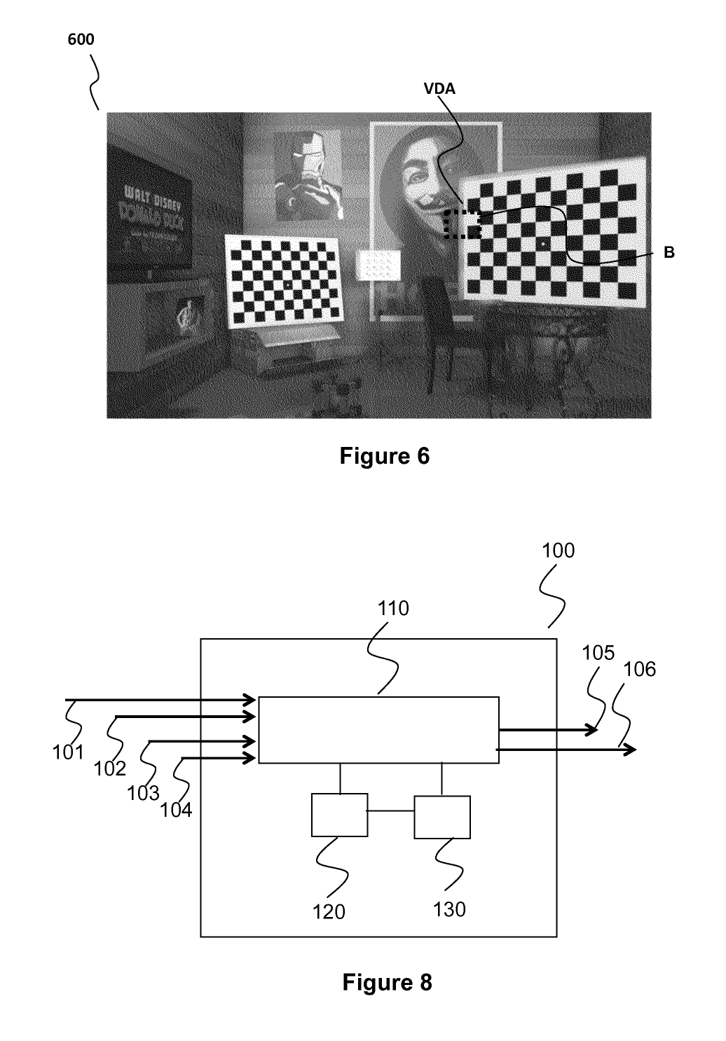

In step 40, the device 100 selects an image area, called out-of-focus area, in one of images of the focal stack, which corresponds to the visual discomfort area but which is out-of-focus. The selection can be performed according to a predetermined selection criterion: for example the device 100 selects the image of the focal stack for which the out-of-focus area has the highest defocus level. Then the device 100 generates a modified view (such as view 600 showed in FIG. 6) as function of the out-of-focus area selected. Indeed, the device 100 combines the information of the focal stack based on the selected out-of-focus area with the original view 200, such that the images parts corresponding to the visual discomfort area has been replaced by the out-of-focus area.

Thus the image parts of the view 200 corresponding to the visual discomfort areas are made blurred to have a better acceptation of occlusions in the multi-view content perceived by the viewer.

To offer a further better acceptation of occlusions, one can envisage choosing several images of the focal stack (FS) for which the out-of-focus area (OFA) has different out-of-focus levels so as to obtain an increasing blurring effect starting from the separation line. To that end, the device 100 selects, not one, but at least two out-of-focus area portions of the out-of-focus area in at least two distinct images of the focal stack assuming that:
the out-of-focus area portion of first level (p1) which extends from the separation line separating the regions R1 and R2 is selected in an image (i1) of first out-of-focus level of the focal stack (FS)
each out-of-focus area portion of inferior level (p2) is selected in an image of inferior out-of-focus level (i2) of the focal stack.

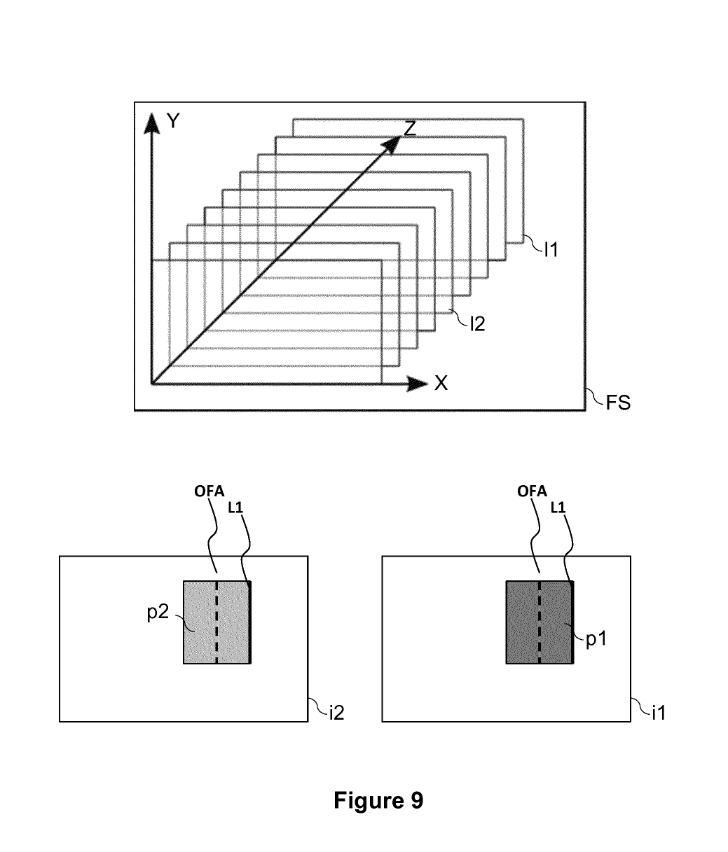

This principle is illustrated in FIG. 9. Focal stack FS is a collection of N images focused at different focalization plans, where N is a user-selected number of images or a limitation required by a device (e.g. memory). Hence, the distance interval, on the z-axis, between two consecutive images in the focal stack 200 corresponds to the distance between two focal planes linked to these two consecutive images. The OFA in image i1 has an out-of-focus level higher than the OFA in image i2. The skilled person is able to define appropriate out-of-focus level based selection criterion and to choose appropriate distance interval to generate an image blur in the final content that is of best quality as possible in order to improve discomfort visual problem.

It should be noted that although the method illustrated here above in relation with FIGS. 1 to 6 is carried out as a function of a depth map, workers skilled in the art will recognize that it is possible to implement the method as a function of a disparity map without departing from the scope of the disclosure.

In addition, in a general manner in the context of content insertion into a multi-view content, the method can further comprise in a general manner a step of inserting, into a foreground plan of the original multi-view content a foreground object content (such as subtitle insertions or graphic insertions for example), the disparity-related map taking into account said at least one foreground object. The steps 10 to 40 can then be applied mutatis mutandis as explained above. Taking into account such an insertion of foreground objects enables to reduce occlusions that could be appeared in the content perceived by the viewer.

FIGS. 7A-7B are schematic illustrations illustrating the principle of defining a depth value difference threshold and a visual discomfort area according to a particular embodiment of the disclosure.

Each figure represents a simplified example of stereoscopic content displayed to a viewer V according to a side view (left figure) and a front view (right figure). These figures show that the disparity difference perceived by the viewer V depends on the distance of the viewer relative to the stereoscopic display.

According to the disclosure, the predefined depth value difference threshold, which is in some way a visual discomfort threshold, can be defined as a function of a binocular angular disparity criterion.

Let note α as being the binocular visual angle defined from a foreground plane FP and β as being the binocular visual angle defined from a background plane BP, as shown in FIG. 7A. The binocular angular disparity criterion to be taken into account to fix the threshold can be defined as a function of the angular deviation between β and α (β-α).

Trials within the skilled person's scope allow selecting an appropriate predefined depth value difference threshold to detect zones that could be source of visual discomfort as a function of desired viewing criteria, criteria relative to the viewer (sensitivity, inter-ocular distance, distance relative to the stereoscopic display etc.).

Regarding FIG. 7B, and as explained above, the visual discomfort area VDA extends over a distance D which is as a function of the depth difference between the first image region (which corresponds to a foreground object) and the second image region (which corresponds to a background object). This is a simplified case in which the depth difference remains identical along the separation line. The distance D over which the visual discomfort area extends is therefore constant.

FIG. 8 shows the simplified structure of an image enhancing device 100 according to a particular embodiment of the disclosure, which carries out the steps 10 to 50 of method shown in FIG. 1.

The device 100 comprises a non-volatile memory 130 is a non-transitory computer-readable carrier medium. It stores executable program code instructions, which are executed by the processor 110 in order to enable implementation of the modified multi-view content obtaining method described above. Upon initialization, the program code instructions are transferred from the non-volatile memory 130 to the volatile memory 120 so as to be executed by the processor 110. The volatile memory 120 likewise includes registers for storing the variables and parameters required for this execution.

According to this particular embodiment, the device 100 receives as inputs two original views 101, 102 intended to stereoscopic viewing and, for each original view, an associated depth map 103 and 104. The device 100 generates as outputs, for each original view, a modified view 105 and 106, forming an enhanced multi-view content as described above.

As will be appreciated by one skilled in the art, aspects of the present principles can be embodied as a system, method or computer readable medium. Accordingly, aspects of the present principles can take the form of an entirely hardware embodiment, an entirely software embodiment (including firmware, resident software, micro-code, and so forth), or an embodiment combining software and hardware aspects that can all generally be referred to herein as a “circuit”, “module”, or “system”.

When the present principles are implemented by one or several hardware components, it can be noted that an hardware component comprises a processor that is an integrated circuit such as a central processing unit, and/or a microprocessor, and/or an Application-specific integrated circuit (ASIC), and/or an Application-specific instruction-set processor (ASIP), and/or a graphics processing unit (GPU), and/or a physics processing unit (PPU), and/or a digital signal processor (DSP), and/or an image processor, and/or a coprocessor, and/or a floating-point unit, and/or a network processor, and/or an audio processor, and/or a multi-core processor. Moreover, the hardware component can also comprise a baseband processor (comprising for example memory units, and a firmware) and/or radio electronic circuits (that can comprise antennas) which receive or transmit radio signals. In one embodiment, the hardware component is compliant with one or more standards such as ISO/IEC 18092/ECMA-340, ISO/IEC 21481/ECMA-352, GSMA, StoLPaN, ETSI/SCP (Smart Card Platform), GlobalPlatform (i.e. a secure element). In a variant, the hardware component is a Radio-frequency identification (RFID) tag. In one embodiment, a hardware component comprises circuits that enable Bluetooth communications, and/or Wi-fi communications, and/or Zigbee communications, and/or USB communications and/or Firewire communications and/or NFC (for Near Field) communications.

Furthermore, aspects of the present principles can take the form of a computer readable storage medium. Any combination of one or more computer readable storage medium(s) may be utilized.

A computer readable storage medium can take the form of a computer readable program product embodied in one or more computer readable medium(s) and having computer readable program code embodied thereon that is executable by a computer. A computer readable storage medium as used herein is considered a non-transitory storage medium given the inherent capability to store the information therein as well as the inherent capability to provide retrieval of the information therefrom. A computer readable storage medium can be, for example, but is not limited to, an electronic, magnetic, optical, electromagnetic, infrared, or semiconductor system, apparatus, or device, or any suitable combination of the foregoing. It is to be appreciated that the following, while providing more specific examples of computer readable storage mediums to which the present principles can be applied, is merely an illustrative and not exhaustive listing as is readily appreciated by one of ordinary skill in the art: a portable computer diskette; a hard disk; a read-only memory (ROM); an erasable programmable read-only memory (EPROM or Flash memory); a portable compact disc read-only memory (CD-ROM); an optical storage device; a magnetic storage device; or any suitable combination of the foregoing.

Thus for example, it will be appreciated by those skilled in the art that the block diagrams presented herein represent conceptual views of illustrative system components and/or circuitry embodying the principles of the disclosure. Similarly, it will be appreciated that any flow charts, flow diagrams, state transition diagrams, pseudo code, and the like represent various processes which may be substantially represented in computer readable storage media and so executed by a computer or a processor, whether or not such computer or processor is explicitly shown.

Although the present disclosure has been described with reference to one or more examples, workers skilled in the art will recognize that changes may be made in form and detail without departing from the scope of the disclosure and/or the appended claims.

1. A method for obtaining a modified multi-view content from an original multi-view content, wherein said method comprises:
determining, from a disparity-related map, at least one separation line separating adjacent first and second image regions, said at least one separation line comprising at least one line portion each separating adjacent first and second image portions belonging respectively to the first image region and the second image region and such that a disparity-related value difference between the first and the second image portion is higher than a disparity-related value difference threshold;
and for said at least one separation line:
obtaining (40) a modified multi-view content by blurring a visual discomfort area that is an area of the second image region, which extends from said at least one separation line over a given distance, and
wherein blurring said visual discomfort area comprises applying an image blurring function, belonging to the group comprising:
a linear decreasing blurring function starting from said separation line;
a non-linear decreasing blurring function starting from said separation line.

2. The method according to claim 1, wherein:
the disparity-related map is a disparity map,
the disparity-related value difference is a difference of disparity,
a first image portion of the first image region is defined as having a disparity lower than that of the corresponding adjacent second image portion of the second image region.

3. The method according to claim 1, wherein:
the disparity-related map is a depth map,
the disparity-related value difference is a difference of depth,
a first image portion of the first image region is defined as having a depth lower than that of the corresponding adjacent second image portion of the second image region.

4. The method according to claim 1, wherein the given distance over which said visual discomfort area extends from said separation line is a predefined distance.

5. The method according to claim 1, wherein the given distance over which said visual discomfort area extends from said separation line depends on the disparity-related value difference between the first and second image portion separated each line portion of said at least one separation line.

6. The method according to claim 1, wherein the disparity-related value difference threshold is defined as a function of a binocular angular disparity criterion.

7-10. (canceled)

11. The method according to claim 1, wherein the original multi-view content is a stereoscopic content comprising two stereoscopic views, each associated with a disparity-related map, said blurring being carried out for each stereoscopic view.

12. The method according to claim 1, wherein the original multi-view content is a synthesized content comprising two synthesized stereoscopic views, each associated with a disparity-related map, and said blurring being carried out for each stereoscopic view.

13. The method according to claim 1, further comprising inserting, into a foreground plan of the original multi-view content, at least one foreground object, the disparity-related map taking into account said at least one foreground object.

14. A computer program product comprising program code instructions for implementing the method according to claim 1.

15. A device for obtaining a modified multi-view content from an original multi-view content, said device comprising at least one processor and a memory coupled to said at least one processor, wherein the at least one processor is configured to:
determine, from a disparity-related map, at least one separation line separating adjacent first and second image regions, said at least one separation line comprising at least one line portion each separating adjacent first and second image portions belonging respectively to the first image region and the second image region and such that a disparity-related value difference between the first and the second image portion is higher than a disparity-related value difference threshold;
and for said at least one separation line, the at least one processor is further configured to:
blur a visual discomfort area to obtain a modified multi-view content, said visual discomfort area being an area of the second image region, in the original multi-view content, which extends from said at least one separation line over a given distance and
wherein the processor, when it is configured to blur, is further configured to apply an image blurring function, belonging to the group comprising:
a linear decreasing blurring function starting from said separation line;
a non-linear decreasing blurring function starting from said separation line.
